(19) United States
(12) Patent Application Publication
(10) Pub. No.: US 2025/0184811 A1
(43) Pub. Date: Jun. 5, 2025

(54) CORRELATING A QUALITY-OF-SERVICE (QOS) MONITORING REPORT WITH A PACKET FLOW

(71) Applicant: Telefonaktiebolaget LM Ericsson (publ), Stockholm (SE)

(72) Inventors: Yong YANG, Kållered (SE); Fuencisla GARCIA AZORERO, Madrid (ES); Junyi HUANG, Mölndal (SE)

(73) Assignee: Telefonaktiebolaget LM Ericsson (publ), Stockholm (SE)

(21) Appl. No.: 18/862,042

(22) PCT Filed: May 2, 2023
(86) PCT No.: PCT/EP2023/061509

§ 371 Date: Oct. 31, 2024

Related U.S. Application Data
(60) Provisional application No. 63/337,655, filed on May 3, 2022.
(60) Provisional application No. 63/337,662, filed on May 3, 2022.

(51) Int. Cl. H04W 28/02; H04L 43/062; H04W 24/08

(52) U.S. Cl. CPC H04W 28/0268; H04L 43/062; H04W 24/08

(57) ABSTRACT

Disclosed herein is a method performed by a UPF 302, the method comprising: receiving a request message transmitted by a management function, MF, the request message comprising: i) first packet detection information, PDI, comprising one or more of an application identifier, AppID, that identifies an application or a first flow description, FD, that defines a first packet flow; ii) first quality-of-service, QoS, enforcement information, QEI, associated with the first PDI, the first QEI comprising a first flow identifier, FI, that identifies a first QoS flow to which the first packet flow is bound; and iii) first monitoring control information, MCI, the first MCI comprising the first FI; obtaining first QoS information pertaining to the packet flow bound to the QoS flow identified by the first FI; and transmitting a first notification comprising: i) the obtained first QoS information and ii) one or both of the AppID or the first FD.

### TECHNICAL FIELD

Disclosed are embodiments related to quality-of-service (QoS) monitoring.

### BACKGROUND

### FIG. 1

FIG. 1 illustrates an exemplifying wireless communication system 100 represented as a 5G network architecture comprising an Access Network (AN) (e.g., a Radio AN (RAN)) and a Core network (CN) comprising network entities in the form of Network Functions (NFs). Typically, the AN comprises base stations, e.g., such as evolved Node Bs (eNBs) or 5G base stations (gNBs) or similar. As shown in FIG. 1, user equipments (UEs) connect to an as well as an Access and Mobility Management Function (AMF). As further shown in FIG. 1, the 5G CN NFs include: a User Plane Function (UPF), a Network Slice Selection Function (NSSF), an Authentication Server Function (AUSF), a Unified Data Management (UDM), an Access and Mobility Management Function (AMF), a Session Management Function (SMF), a Policy Control Function (PCF), an Application Function (AF), a NF Repository Function (NRF), and a Network Exposure Function (NEF).

A number of 5G core network NFs of different types are typically instantiated per default in the 5G core network, e.g., such as an AMF, a NRF, a PCF and a SMF etc. Other 5G core network NFs may be instantiated as needed and several NFs of the same type can also be instantiated if required, e.g., to distribute load to additional NF(s) of the same type. Thus, an NF instance may be seen as an example or a specimen of a certain NF. Herein, the terms NF and NF instance are used interchangeably, unless otherwise expressly stated or is apparent from the context in which the terms are used. An NF instance exposes one or more NF Service Instances.

### Mapping User Plane Traffic to QoS Flows

### FIG. 2

The principle mapping user plane (UP) traffic to QoS Flows and to AN resources is illustrated in FIG. 2.

Downlink (DL) data packets (i.e., packets received at UPF and then transmitted towards the UE) are classified by the UPF based on DL Packet Detection Rules (PDRs) received from the SMF in the order of their precedence. That is, once a DL packet is determined by UPF to match a flow description (a.k.a., filter) included in the PDR, then the packet is bound to a QoS flow associated with the PDR by marking the patent with the QoS Flow Identifier (QFI) that identifies the QoS flow. The AN binds QoS Flows to AN resources (i.e. Data Radio Bearers in the case of 3GPP RAN). There is no strict 1:1 relation between QoS Flows and AN resources. It is up to the AN to establish the necessary AN resources that QoS Flows can be mapped to, and to release them. If no matching DL PDR is found, the UPF shall discard the DL data packet.

In the UL direction, for a PDU Session of Type IP or Ethernet, the UE evaluates UL packets against UL Packet Filters in a Packet Filter Set in QoS rules based on the precedence value of QoS rules in increasing order until a matching QoS rule (i.e. whose Packet Filter matches the UL packet) is found. If no matching QoS rule is found, the UE shall discard the UL data packet. The UE uses the QFI in the corresponding matching QoS rule to bind the UL packet to a QoS Flow. The UE then binds QoS Flows to AN resources.

### QoS Monitoring in 3GPP

The QoS Monitoring mentioned here corresponds to the QoS Monitoring that is specified in the 3GPP specifications. For example, as described in 3GPP Technical Specification 23.501 V17.4.0 (“TS 23.501”), QoS Monitoring is applied for packet delay measurement. The packet delay between UE and the Protocol Data Unit (PDU) Session Anchor (PSA) UPF is a combination of the RAN part of UL/DL packet delay and UL/DL packet delay between the RAN and UPF. The RAN is required to provide the QoS Monitoring on the RAN part of UL/DL packet delay measurement. The QoS Monitoring on UL/DL packet delay between RAN and UPF can be performed on different levels of granularities, i.e. per QoS Flow per UE level, or per GTP-U path level, subject to the operators' configuration, and/or 3rd party application request, and/or PCF policy control.

The PCF generates the authorized QoS Monitoring policy for a service data flow based on a QoS Monitoring request if received from an AF. The PCF includes the authorized QoS Monitoring policy in a PCC rule and provides the PCC rule to the SMF, which then provides PDR(s), QER(s), and SRR(s) to the UPF.

As described in 3GPP TS 23.503 V17.4.0 (“TS 23.503”), the QoS Monitoring policy includes the following:
1) QoS parameters to be measured (DL, UL or round trip packet delay);
2) frequency of reporting (event triggered, periodic, when no packet delay measurement result is received for a delay exceeding a threshold, or when the PDU Session is released); if the reporting frequency is event triggered, the policy includes the corresponding reporting threshold to each QoS parameter and minimum waiting time between subsequent reports; else if the reporting frequency is periodic, the policy includes the reporting period; threshold for reporting packet delay measurement failure;
3) information about the target of the QoS Monitoring reports (e.g. the PCF or the AF or the Local NEF indicated as Notification Target Address+Notification Correlation ID as specified in clause 4.15.1 of 3GPP TS 23.502 V17.4.0 (“TS 23.502”);
4) an indication of direct event notification (to request the UPF to directly report QoS Monitoring information to the Local NEF or the AF as described in clause 6.4 of 3GPP TS 23.548 V17.2.0 (“TS 23.548”).

### QoS Monitoring Per QoS Flow Per UE

SMF may activate the end to end UL/DL packet delay measurement between UE and UPF for a QoS Flow during the PDU Session Establishment or Modification procedure. The SMF sends a QoS Monitoring request to the UPF to request the QoS monitoring between UPF and RAN. The QoS Monitoring request may contain monitoring parameters determined by SMF based on the authorized QoS Monitoring policy received from the PCF and/or local configuration. The RAN initiates the RAN part of UL/DL packet delay measurement based on the QoS Monitoring request from SMF. RAN reports the RAN part of UL/DL packet delay result to the UPF in the UL data packet or dummy UL packet.

As described in TS 23.548, some real time network information, e.g. user path latency, are useful for application layer, and, in order to expose network information timely to local AF, the UPF may provide QoS monitoring results to the AF.

The UPF may be instructed to report information about a PDU Session directly to the AF or NEF (i.e., bypassing the SMF and the PCF). NEF deployed at the edge may be used to support network exposure with low latency to AF.

In one scenario, AF subscribes to the QoS Monitoring results from the PCF via a NEF. The AF may also subscribe the Npcf_PolicyAuthorization_Subscribe service via PCF directly. In this case, reporting is done directly from the UPF to the local AF.

Based on the indication of direct event notification and operator's policy, the PCF may include an indication of direct event notification (including target local NEF address or target AF address) within the PCC rule that it provides to the SMF.

The SMF sends the QoS monitoring request to the RAN and N4 rules to the UPF. The N4 rules may indicate the service data flow needs local notification of QoS Monitoring. When N4 rules indicate the service data flow needs local notification of QoS Monitoring, upon the detection of the QoS monitoring event (e.g. when latency threshold of the QoS flow is reached), the UPF notifies the QoS Monitoring event information to the AF (directly or via Local NEF). In particular, the UPF sends the Nupf_EventExposure_Notify to the Notification Target Address indicated by the Session Reporting Rule (SRR) received from the SMF. The Notification Target Address may correspond to the AF or to a local NEF. When the Notification Target Address corresponds to a Local NEF, the local NEF reports the QoS Monitoring information to the AF.

### The Nsmf_EventExposure Service

This service provides events related to PDU Sessions towards consumer NF (e.g., AF or NEF). The service operations exposed by this service allow other NFs to subscribe and get notified of events happening on PDU Sessions. The following are the key functionalities of this NF service: 1) allow consumer NFs to Subscribe and unsubscribe for an Event ID on PDU Session(s); 2) allow the NWDAF to collect data for network data analytics; 3) notifying events on the PDU Session to the subscribed NFs; and 4) allow consumer NFs to acknowledge or respond to an event notification. Many events can be subscribed by a NF consumer, including QFI allocation. The QFI allocation event notification is sent when a new QoS flow is established within a PDU session. If the Target of Event Reporting is a PDU session, the event notification contains both the allocated QFI and either one of the following (Application Identifier or IP Packet Filter Set or Ethernet Packet Filter Set). The DNN, S-NSSAI corresponding to the PDU session are also sent. If the Target of Event Reporting is a SUPI, the event notification contains both the allocated QFI and either one of the following (Application Identifier or IP Packet Filter Set or Ethernet Packet Filter Set) for each PDU session ID established for this SUPI. The DNN, S-NSSAI corresponding to each PDU session are also sent. If the Target of Event Reporting is an Internal-Group-Id or any UE, the event notification contains multiple instances of the tuple (allocated QFI and either one of the following (Application Identifier or IP Packet Filter Set or Ethernet Packet Filter Set). PDU session ID, SUPI). The DNN, S-NSSAI corresponding to each PDU session are also sent.

### SUMMARY

Certain challenges presently exist. For instance, the QoS Monitoring report message sent by the UPF to the AF or NEF (hereafter “AF/NF”) includes or consists of an Information Element (IE) of type NotificationItem that includes QoS Monitoring Measurement information (a.k.a., QoS Monitoring Report) (e.g., information indicating the end-to-end delay for a specific QoS flow of a PDU session) and a QFI that identifies the QoS Flow to which the QoS Monitoring Report pertains. But if the AF/NF provides a service comprising two or more service data flows (a.k.a., “packet flows” or “media components”), where each service data flow is bound to a different QoS Flow, then the AF/NF will not know the service data flow to which the QoS Monitoring Report pertains because, for each one of the specific service data flows, the AF/NF is not aware of the QoS Flow to which the specific service data flow is bound. Also, if the AF/NEF is going to use the QFI to correlate the QoS Monitoring Report received from the UPF with the AF/NEF's application id, or media component, the AF/NEF has to subscribe to the QFI allocation event towards the SMF, and this leads to extra signaling in the core network (e.g., signaling towards the UDM and SMF).

Accordingly, in one aspect there is provided a method performed by a UPF. The method includes receiving a request message (e.g., a PFCP Session Modification Request) transmitted by a management function (e.g., SMF). The request message includes first packet detection information (PDI) (e.g., a PDR) comprising one or more of an application identifier (AppID) that identifies an application (e.g., an application provided by an AF or Application Server (AS)) or a first FD that defines a first packet flow. The request message also includes first QoS enforcement information (QEI) (e.g., a QoS Enforcement Rule (QER) associated with the first PDI, the first QEI comprising a first flow identifier (FI) (e.g., QoS FI (QFI)) that identifies a first QoS flow to which the first packet flow is bound. The request message further includes first monitoring control information (MCI) (e.g., the QoS Monitoring per QoS Flow Control Information IE included in the Create SRR IE within the PFCP Session Establishment Request message), the first MCI comprising the first FI (the first MCI may also include type information indicating a type of QoS information for the first QoS flow to be reported by the UPF to a network function). The method also includes obtaining first QoS information pertaining to the packet flow bound to the QoS flow identified by the first FI. For example, step s402 may comprise the UPF measuring one or more of: DL packet delay, UL packet delay, or round trip packet delay, or other QoS monitoring measurement information. Hence, the first QoS information may include: a DL packet delay value, an UL packet delay value, and/or a round trip packet delay value. The method further includes transmitting a first notification comprising: i) the obtained first QoS information and ii) one or both of the AppID or the first FD (e.g., transmitting a QoS Monitoring Report message comprising the notification).

In another aspect there is provided a method performed by a network function (NF) (e.g., AF/NEF). The method includes transmitting a message for creating a session, wherein the message comprises i) information requesting QoS monitoring for the session (e.g., a subscription for QoS Monitoring) and ii) at least one of an application identifier (AppID) that identifies an application and/or a first FD that defines a first packet flow. The method also includes receiving a first notification transmitted by the UPF, the first notification comprising: i) first QoS information pertaining to the first packet flow (e.g., a DL packet delay value, an UL packet delay value, and/or a round trip packet delay value) and ii) at least one of the AppID or the first FD, thereby enabling the NF to associate the first QoS information with the AppID and/or first FD.

In another aspect there is provided a computer program comprising instructions which when executed by processing circuitry of a network node causes the network node to perform any one of the methods disclosed herein. In another aspect there is provided a carrier containing the computer program, wherein the carrier is one of an electronic signal, an optical signal, a radio signal, and a computer readable storage medium. In another aspect there is provided a network node, where the network node is configured to perform any one of the methods disclosed herein. In some embodiments, the network node includes processing circuitry and a memory containing instructions executable by the processing circuitry, whereby the network node is configured to perform any one of the methods disclosed herein.

An advantage of the embodiments disclosed herein is that they enable AF/NEF to correlate a received QoS Monitoring Report with an application identifier or media component without increasing the signaling in the network.

### BRIEF DESCRIPTION OF THE DRAWINGS

The accompanying drawings, which are incorporated herein and form part of the specification, illustrate various embodiments.

FIG. 1 illustrates an exemplifying wireless communication system.

FIG. 2 illustrates binding packets to QoS Flows.

FIG. 3 is a message flow diagram illustrating a message flow according to an embodiment.

FIG. 4 is a flowchart illustrating a process according to an embodiment.

FIG. 5 is a flowchart illustrating a process according to an embodiment.

FIG. 6 illustrates a network node according to an embodiment.

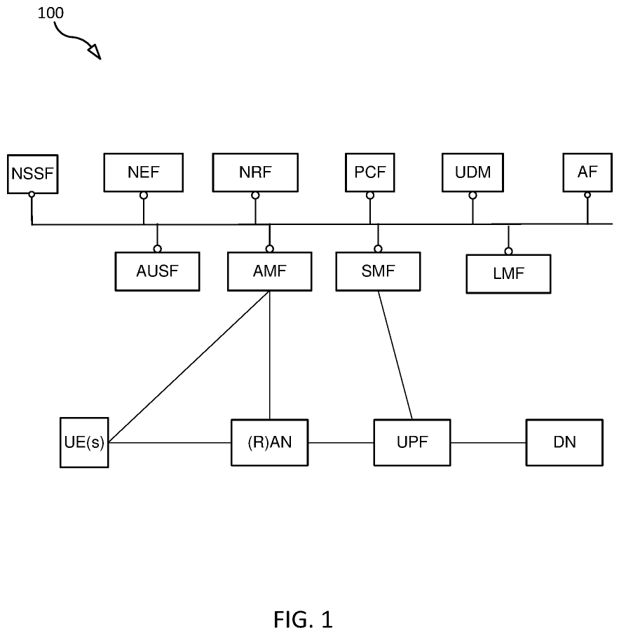

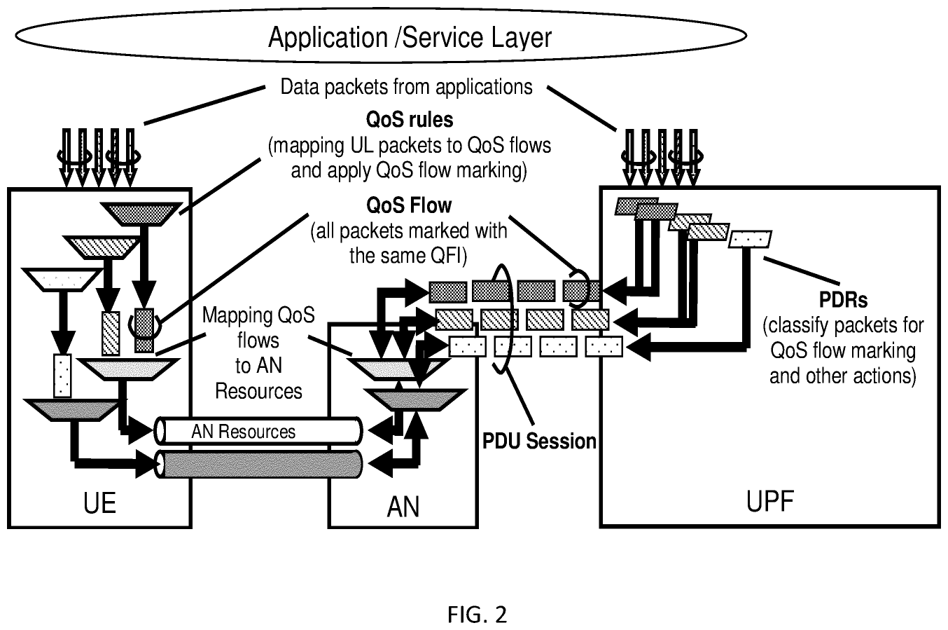

### DETAILED DESCRIPTION

Disclosed are embodiments that enable an AF/NEF to correlate its application id or service data flows (as identified by Ethernet flow descriptions or Internet Protocol (IP) flow description) with a QoS Monitoring Report received from a UPF.

In a 5G network embodiment, when the AMF/NEF requests an SMF to create session for a service (e.g., a service invoked by a particular UE) and further requests QoS monitoring of the service, the SMF, for each packet flow of the service (a.k.a., service data flow), as identified by the application id or a flow description (FD) that defines the packet flow, will create the following: 1) a QoS flow for the packet flow; 2) create a PDR for the packet flow, where the PDR includes the FD that defines the packet flow and/or the application id; 2) a QoS Enforcement rule for the packet flow, wherein the (QER) contains a QoS Flow identifier (QFI) that identifies the QoS flow for the packet flow; and 3) a Session Reporting Rule (SRR). The SMF then sends to the UPF the PDR, QER, and SRR. The SRR, in one example, informs UPF to transmit to the AF/NEF notification data as a result of the UPF detecting an event pertaining to any one of the packet flows, where the notification data comprises at least a first notification item that includes a QoS Monitoring report for the packet flow on which the event was detected and the QFI identifying the QoS flow that was created for the packet flow. The QFI is obtained from the QER associated with the PDR for the packet flow. Advantageously, the notification item further includes the application id and/or the FD that defines the packet flow (the UPF is able to obtain this information from the PDR for the packet flow).

In one embodiment, the notification item is of type NotificationItem, and in one embodiment, the NotificationItem type is defined as shown in Table 1 below:

TABLE 1
Definition of Type NotificationItem

| Attribute name | Data type | P | Cardinality | Description |
|---|---|---|---|---|
| eventType | EventType | M | 1 | The event type of the event for which the |
| | | | | notification is generated. |
| qfi | Qfi | O | 0 . . . 1 | When present, this attribute contains the QFI |
| | | | | of the QoS Flow to which the notification is |
| | | | | subject |
| ueIpv4Addr | Ipv4Addr | C | 0 . . . 1 | IPv4 address of the UE (At least one of |
| | | | | ueIpv4Addr and ueIpv6Prefix shall be present) |
| ueIpv6Prefix | Ipv6Prefix | C | 0 . . . 1 | IPv6 address prefix of the UE (At least one of |
| | | | | ueIpv4Addr and ueIpv6Prefix shall be present) |
| dnn | Dnn | O | 0 . . . 1 | When present, this attribute indicates the DNN |
| | | | | of the PDU session for which the notification is |
| | | | | generated. |
| snssai | Snssai | O | 0 . . . 1 | When present, this attribute indicates the S- |
| | | | | NSSAI of the PDU session for which the |
| | | | | notification is generated. |
| gpsi | Gpsi | O | 0 . . . 1 | When present, this attribute indicates the |
| | | | | GPSI of the UE for which the notification is |
| | | | | generated. |
| timeStamp | DateTime | M | 1 | The value represents the UTC time when the |
| | | | | information in this report was generated. |
| startTime | DateTime | O | 0 . . . 1 | When present, this attribute shall provide the |
| | | | | timestamp when the information in this report |
| | | | | was started |
| qosMonitoringMeasurement | QosMonitoringMeasurement | C | 0 . . . 1 | This attribute shall be present if eventType is |
| | | | | set to “QOS_MONITORING” |
| appIds | array(ApplicationId) | O | 0 . . . 1 | appIds |
| ethFD | array(EthFlowDescription) | O | 0 . . . 1 | Ethernet FD |
| ipFD | array(FlowDescription) | O | 0 . . . 1 | IP FD |

As shown in Table 1, the notification item may include an array of application ids, an array of Ethernet FDs of type EthFlowDescription, and an array of IP FDs of type FlowDescription. The data types “EthFlowDescrption” and “FlowDescription” are defined in 3GPP TS 29.514 V16.12.0 (“TS 29.514”). In short, a data item of type FlowDescription” contains an IP filter rule (see, e.g. Request For Comments (RFC) 6733). As a simple example, an IP filter rule contains a “source” IP address and a “destination” IP address. An example of an Ethernet FD is a data item that contain: a destination MAC address, and a source MAC address.

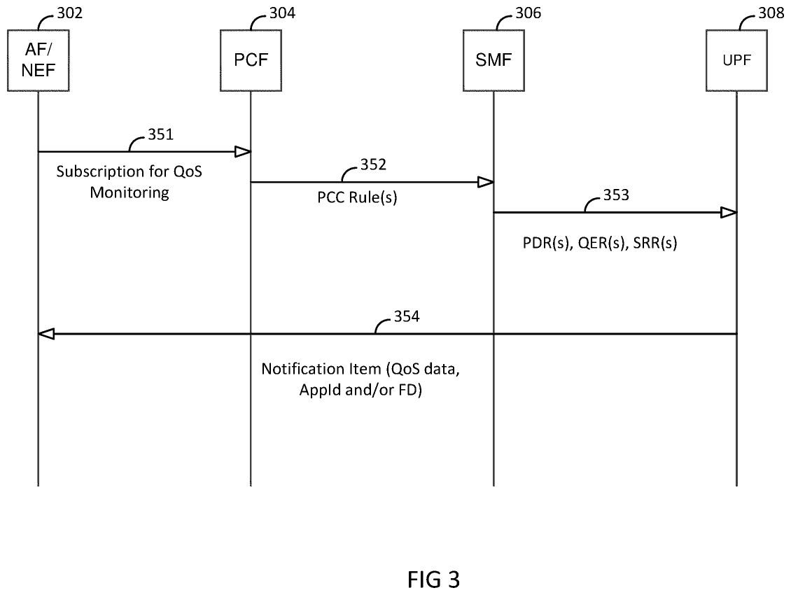

### FIG. 3

FIG. 3 illustrates a message flow illustrating a process according to a 5G embodiment. The process begins with an AF/NEF 302 invoking the Npcf_PolicyAuthorization service to create an application session. The AF/NEF may be triggered to invoke this service in response to a UE requesting a service supported by the AF. Invoking the Npcf_PolicyAuthorization service comprises the AF/NEF transmitting to PCF 304 a message 351 (e.g., an HTTP message) that includes one or more application ids, one or more FD (e.g., one or more IP FDs and/or one or more Ethernet FDs), and a subscription for QoS monitoring, which subscription includes a notification Uniform Resource Identifier (URI) and a notification correlation ID. For example, the subscription for QoS monitoring that is included in message 351 may be data that is of type EventsSubscReqData, which is defined in 3GPP TS 29.514 V17.4.0 (“TS 29.514”).

After receiving the message 351 from the AF/NEF, the PCF creates one or more PCC rules with a reference to QoS monitoring data as requested including the notification URI and the notification correlation ID. The PCF then invokes the Npcf_SMFPolicyControl Service. That is, the PCF then sends to an SMF 306 a message 352 comprising the PCC rule(s).

After receiving message 352, the SMF, based on the PCC rule(s) which contains QoS monitoring request, the SMF creates the PDR(s), QER(s), and SRR(s), where each PDR contains the packet detection information that includes the application id and/or one of the FDs, and associates the PDR(s) with the corresponding QER(s), where each QER defines a separate QoS flow (each QoS flow being identified by a QFI). Each SRR includes one of the QFIs as well as the notification URI and notification correlation id. The SMF then requests a UPF 308 to perform QoS monitoring by providing to the UPF the PDR(s), QER(s), and SRR(s). For example, the SMF sends to the UPF a PFCP Session Modification request message 353 containing the PDR(s), QER(s), and SRR(s). Because an SRR includes a QFI, UPF is able to determine the QoS flow (QER) corresponding to the SRR (i.e., the QER that contains said QFI), and because this QER is associated with a single PDR, the UPF is able to obtain the application id and/or FD associated with the QoS Flow being monitored.

After receiving the message 353 from the SMF, the UPF performs QoS monitoring for the given QoS Flows identified by the QFIs in the SRRs received from the SMF.

For example, when the UPF receives a DL packet, the UPF will, for one or more of the PDRs that it received from the SMF in message 353, determine whether the packet matches the PDR based on a packet filter (e.g., FD) included in the PDR. When UPF detects that the DL packet matches a PDR, the UPF will get the QFI associated with the matching PDR (e.g., it may get the QFI from the QER associated with the matching PDR). After getting the QFI, the UPF will determine whether there is an SRR that contains the QFI, and, if there is, the UPF will perform QoS monitoring as directed by the SRR.

For instance, the UPF may determine a packet round-trip time by recording the time at which it transmits the DL packet to the AN and recording the time that it receives from the AN a packet corresponding to the DL packet. By recording these times, UPF can calculate a round-trip time. In this example, the SSR containing the QFI associated with the PDR that the DL matched configures the UPF such that, as a result of UPF detecting an event (e.g., determining that the round-trip time (or a calculated average round-trip time) exceeds a threshold), the UPF sends to the AF a notification message 354 comprising a notification item related to the detected event. As noted above, advantageously, the notification item includes the application id and/or the FD that was included in the PDR to which the DL packet matched. More specifically, the UPF sends the notification message 354 to the address indicated in the notification URI included in the SRR, and the notification message 354 also contains the notification correlation id included in the SRR, which will be the same notification correlation id that the AF included in the subscription for QoS monitoring sent to the PCF.

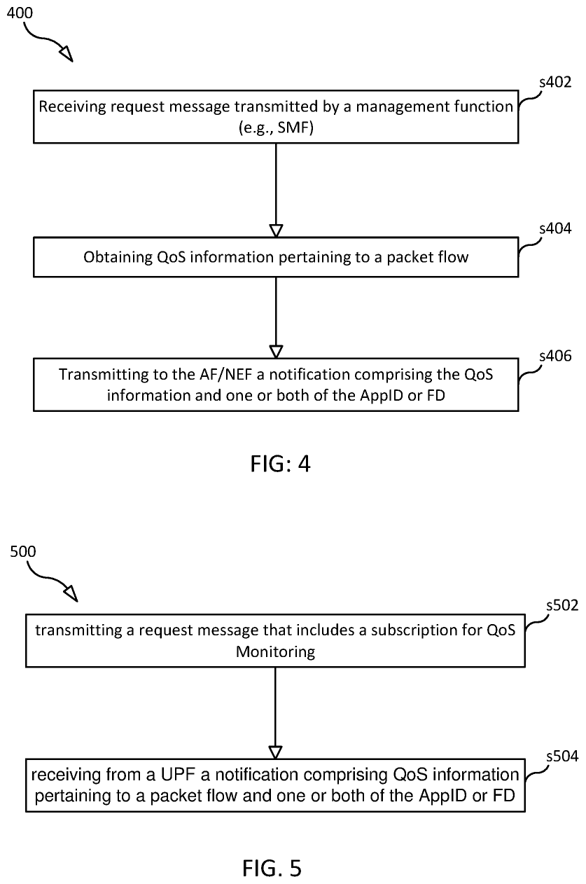

### FIG. 4

FIG. 4 is a flowchart illustrating a process 400 according to an embodiment. Process 400 is performed by UPF 308 and may begin in step s402.

Step s402 comprises receiving a request message (e.g., a PFCP Session Modification Request 353) transmitted by a management function (e.g., SMF 306). The request message comprises: i) first packet detection information (PDI) (e.g., a PDR) comprising one or more of an application identifier (AppID) that identifies an application (e.g., an application provided by an AF 302 or Application Server (AS) or a first FD that defines a first packet flow; ii) first QoS enforcement information (QEI) (e.g., a QoS Enforcement Rule (QER)) associated with the first PDI, the first QEI comprising a first flow identifier (FI) (e.g., QoS FI (QFI) that identifies a first QoS flow to which the first packet flow is bound; and iii) first monitoring control information (MCI) (e.g., the QoS Monitoring per QoS Flow Control Information IE included in the Create SRR IE within the PFCP Session Establishment Request message 353), the first MCI comprising the first FI (the first MCI may also include type information indicating a type of QoS information for the first QoS flow to be reported by the UPF to a network function).

Step s404 comprises obtaining first QoS information pertaining to the packet flow bound to the QoS flow identified by the first FI. For example, step s402 may comprise the UPF measuring one or more of: DL packet delay, UL packet delay, or round trip packet delay, or other QoS monitoring measurement information. Hence, the first QoS information may include: a DL packet delay value, an UL packet delay value, and/or a round trip packet delay value.

Step s406 comprises transmitting a first notification comprising: i) the obtained first QoS information and ii) one or both of the AppID or the first FD (e.g., transmitting a QoS Monitoring Report message comprising the notification). In some embodiments, the first notification further comprises an event type indicator indicating an event for which the notification is generated.

In some embodiments, the request message comprises the first FD, and the first FD is either an Ethernet FD that comprises an Ethernet filter or an Internet Protocol (IP) FD that comprises an IP filter (e.g., the IP FD comprises or consists of first IP address (e.g., an IP address of a user equipment) and a second IP address (e.g., the applications IP address)).

In some embodiments, obtaining the first QoS information comprises determining a performance indicator (e.g., packet delay or other performance indicator) for the first QoS flow.

In some embodiments, the request message comprises the first FD and the request message further comprises: i) a second PDI comprising a second FD that defines a second packet flow, ii) a second QEI associated with the second PDI, the second QEI comprising a second FI, that identifies a second QoS flow for packets that belong to the second packet flow, and iii) second MCI comprising the second FI and type information indicating a type of QoS information for the second QoS flow to be reported by the UPF to the network function; obtaining second QoS information of the type indicated by the type information included in the second MCI; and transmitting to the network function a second notification comprising: i) the obtained second QoS information and ii) the second FD. In some embodiments, obtaining the second QoS information comprises determining a performance indicator (e.g., packet delay or other performance indicator) for the second QoS flow.

In some embodiments, transmitting the first and second notifications comprises transmitting a notification request message comprising the first notification and the second notification. In some embodiments, the request message comprises reporting information (e.g., a Create SRR IE within the PFCP Session Establishment Request) that comprises the first MCI, the second MCI, a target address, and a correlation identifier, transmitting the notification request message comprises transmitting the notification request message to the target address, and the notification further comprises the correlation ID.

### FIG. 5

FIG. 5 is a flowchart illustrating a process 500 according to an embodiment. Process 500 is performed by AF/NEF 302 and may begin in step s502.

Step s502 comprises transmitting a message 351 for creating a session, wherein the message comprises i) information requesting QoS monitoring for the session (e.g., a subscription for QoS Monitoring) and ii) at least one of an application identifier (AppID) that identifies an application and/or a first FD that defines a first packet flow.

Step s504 comprises receiving a first notification 354 transmitted by the UPF, the first notification comprising: i) first QoS information pertaining to the first packet flow (e.g., a DL packet delay value, an UL packet delay value, and/or a round trip packet delay value) and ii) at least one of the AppID or the first FD, thereby enabling the NF to associate the first QoS information with the AppID and/or first FD.

In some embodiments, the notification further comprises an event type indicator indicating an event for which the notification is generated.

In some embodiments, the message comprises the first FD, and the first FD is either an Ethernet FD or an IP FD. In some embodiments, the first QoS information comprises a QoS monitoring report. In some embodiments, the QoS monitoring report comprises packet delay information for the first packet flow.

In some embodiments, the message comprises the first FD, the message further comprises a second FD that defines a second packet flow, and the method further comprises receiving a second notification transmitted by the UPF, the second notification comprising: i) second QoS information for the second packet flow and ii) the second FD, thereby enabling the NF to associate the second QoS information with the second FD. In some embodiments, receiving the first and second notifications comprises receiving a notification request message comprising the first notification and the second notification. In some embodiments, the message for creating the session further comprises a target address indicating an address of the network function and a correlation identifier, and the notification request message further comprises the correlation identifier.

In some embodiments, the network function is an Application Function or a Network Exposure Function.

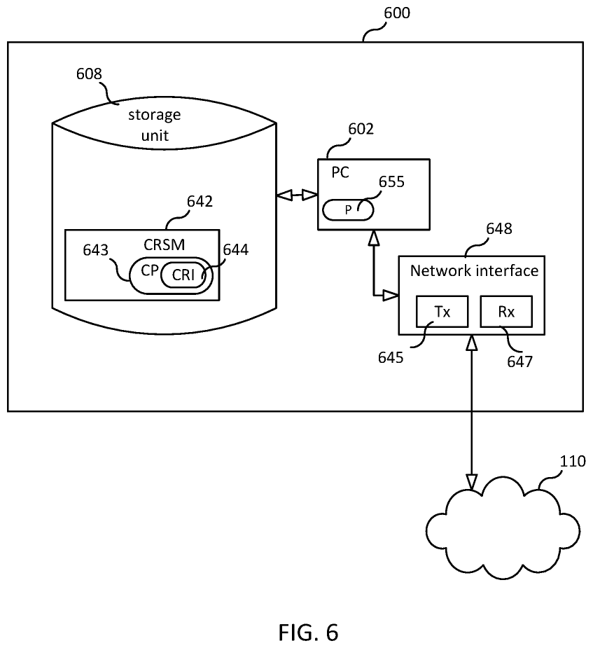

### FIG. 6

FIG. 6 is a block diagram of a network node 600, according to some embodiments, which can be used to implement any of the network functions (NFs) disclosed herein (e.g., AF, NEF, PCF, SMF, UPF). For instance, in embodiments where an NF consists of software, network node 600 may run (or execute a virtual machine that runs) the NF. As shown in FIG. 6, network node 600 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 600 may be a distributed computing apparatus); at least one network interface 648 (e.g., a physical interface or air interface) comprising a transmitter (Tx) 645 and a receiver (Rx) 647 for enabling network node 600 to transmit data to and receive data from other nodes connected to a network 110 (e.g., an Internet Protocol (IP) network) to which network interface 648 is connected (physically or wirelessly) (e.g., network interface 648 may be coupled to an antenna arrangement comprising one or more antennas for enabling network node 600 to wirelessly transmit/receive data); and a storage unit (a.k.a., “data storage system”) 608, which may include one or more non-volatile storage devices and/or one or more volatile storage devices. In embodiments where PC 602 includes a programmable processor, a computer readable storage medium (CRSM) 642 may be provided. CRSM 642 may store a computer program (CP) 643 comprising computer readable instructions (CRI) 644. CRSM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes network node 600 to perform steps described herein (e.g., steps described herein with reference to the flow charts). In other embodiments, network node 600 may be configured to perform steps described herein without the need for code. That is, for example, PC 602 may consist merely of one or more ASICs. Hence, the features of the embodiments described herein may be implemented in hardware and/or software.

### Summary of Various Embodiments

Some embodiments described above may be summarized in the following manner:
A1. A method 400 performed by a user plane function, UPF 308, the method comprising:
receiving a request message (e.g., a PFCP Session Modification Request 353) transmitted by a management function, MF, the request message comprising:
   i) first packet detection information, PDI, (e.g., a Packet Detection Rule (PDR)) comprising one or more of an application identifier, AppID, that identifies an application (e.g., an application provided by an Application Function (AF) or Application Server (AS) or a first flow description, FD, that defines a first packet flow;
   ii) first quality-of-service, QoS, enforcement information, QEI, (e.g., a QoS Enforcement Rule (QER)) associated with the first PDI, the first QEI comprising a first flow identifier, FI, that identifies a first QoS flow to which the first packet flow is bound; and
   iii) first monitoring control information, MCI (e.g., the “QoS Monitoring per QoS Flow Control Information” IE included in the Create SRR IE within the PFCP Session Establishment Request message), the first MCI comprising the first FI (the first MCI may also include type information indicating a type of QoS information for the first QoS flow to be reported by the UPF to a network function);
obtaining first QoS information pertaining to the packet flow bound to the QoS flow identified by the first FI; and
transmitting a first notification comprising: i) the obtained first QoS information and ii) one or both of the AppID or the first FD (e.g., transmitting a QoS Monitoring Report message comprising the notification).
A2. The method of embodiment A1, wherein the notification further comprises an event type indicator indicating an event for which the notification is generated.
A3. The method of embodiment A1 or A2, wherein
the request message comprises the first FD, and
the first FD is either an Ethernet FD that comprises an Ethernet filter or an Internet Protocol, IP, FD that comprises an IP filter (e.g., the IP FD comprises or consists of first IP address (e.g., an IP address of a user equipment) and a second IP address (e.g., the applications IP address).
A4. The method of embodiment A3, wherein
obtaining the first QoS information comprises determining a performance indicator (e.g., packet delay or other performance indicator) for the first QoS flow.
A5. The method of any one of embodiments A1-A4, wherein the request message comprises the first FD and the request message further comprises:
   i) a second PDI comprising a second FD that defines a second packet flow,
ii) a second QEI associated with the second PDI, the second QEI comprising a second FI, that identifies
   a second QoS flow for packets that belong to the second packet flow, and
   iii) second MCI comprising the second FI and type information indicating a type of QoS information for the second QoS flow to be reported by the UPF to the network function;
obtaining second QoS information of the type indicated by the type information included in the second MCI; and
transmitting to the network function a second notification comprising: i) the obtained second QoS information and ii) the second FD.
A6. The method of embodiment A5, wherein
obtaining the second QoS information comprises determining a performance indicator (e.g., packet delay) for the second QoS flow.
A7. The method of embodiment A5 or A6, wherein transmitting the first and second notifications comprises transmitting a notification request message comprising the first notification and the second notification.
A8. The method of embodiment A7, wherein
the request message comprises reporting information (e.g., a Create SRR IE within the PFCP Session Establishment Request) that comprises the first MCI, the second MCI, a target address, and a correlation identifier,
transmitting the notification request message comprises transmitting the notification request message to the target address, and
the notification further comprises the correlation ID.
B1. A method performed by a network function, NF, 302 the method comprising:
transmitting a message for creating a session, wherein the message comprises i) information requesting quality-of-service, QoS, monitoring for the session and ii) at least one of an application identifier, AppID, that identifies an application and/or a first flow description, FD, that defines a first packet flow; and
receiving a first notification transmitted by a user plane function, UPF, the first notification comprising: i) first QoS information pertaining to the first packet flow and ii) at least one of the AppID or the first FD, thereby enabling the NF to associate the first QoS information with the AppID and/or first FD.
B2. The method of embodiment B1, wherein the notification further comprises an event type indicator indicating an event for which the notification is generated.
B3. The method of embodiment B1 or B2, wherein
the message comprises the first FD, and
the first FD is either an Ethernet FD or an Internet Protocol, IP, FD.
B4. The method of embodiment B3, wherein
the first QoS information comprises a QoS monitoring report.
B5. The method of embodiment B4, wherein the QoS monitoring report comprises packet delay information for the first packet flow.
B6. The method of any one of embodiments B1-B5, wherein
the message comprises the first FD,
the message further comprises a second FD that defines a second packet flow, and
the method further comprises receiving a second notification transmitted by the UPF, the second notification comprising: i) second QoS information for the second packet flow and ii) the second FD, thereby enabling the NF to associate the second QoS information with the second FD.
B7. The method of embodiment B5 or B6, wherein receiving the first and second notifications comprises receiving a notification request message comprising the first notification and the second notification.
B8. The method of embodiment B7, wherein
the message for creating the session further comprises a target address indicating an address of the network function and a correlation identifier,
and the notification request message further comprises the correlation identifier.
B9. The method of any one of embodiments B1-B8, wherein the network function is:
an Application Function, or
a Network Exposure Function.
C1. A computer program (643) comprising instructions (644) which when executed by processing circuitry (655) of a network node (600) causes the network node to perform the method any one of the above embodiments.
C2. A carrier containing the computer program of embodiment D1, wherein the carrier is one of an electronic signal, an optical signal, a radio signal, and a computer readable storage medium (642).
D1. A network node (600), where the network node is configured to perform the method any one of above method embodiments.
E1. A network node (600), wherein the network node includes processing circuitry (655) and a memory (642) containing instructions (644) executable by the processing circuitry, whereby the network node is configured to perform the method any one of the above method embodiments.

1. A method performed by a user plane function (UPF), the method comprising:
receiving a request message transmitted by a management function (MF), the request message comprising:
i) first packet detection information (PDI) comprising one or more of an application identifier (AppID), that identifies an application or a first flow description (FD) that defines a first packet flow;
ii) first quality-of-service, (QoS) enforcement information (QEI) associated with the first PDI, the first QEI comprising a first flow identifier (FI) that identifies a first QoS flow to which the first packet flow is bound; and
iii) first monitoring control information (MCI), the first MCI comprising the first FI;
obtaining first QoS information pertaining to the packet flow bound to the QoS flow identified by the first FI; and
transmitting a first notification comprising: i) the obtained first QoS information and ii) one or both of the AppID or the first FD.

2. The method of claim 1, wherein the notification further comprises an event type indicator indicating an event for which the notification is generated.

3. The method of claim 1, wherein
the request message comprises the first FD, and
the first FD is either an Ethernet FD that comprises an Ethernet filter or an Internet Protocol (IP) FD that comprises an IP filter.

4. (canceled)

5. The method of claim 1, wherein the request message comprises the first FD and the request message further comprises:
i) a second PDI comprising a second FD that defines a second packet flow,
ii) a second QEI associated with the second PDI, the second QEI comprising a second FI, that identifies a second QoS flow for packets that belong to the second packet flow, and
iii) second MCI comprising the second FI and type information indicating a type of QoS information for the second QoS flow to be reported by the UPF to the network function;
obtaining second QoS information of the type indicated by the type information included in the second MCI; and
transmitting to the network function a second notification comprising: i) the obtained second QoS information and ii) the second FD.

6. The method of claim 5, wherein
obtaining the second QoS information comprises determining a performance indicator for the second QoS flow.

7. The method of claim 5, wherein transmitting the first and second notifications comprises transmitting a notification request message comprising the first notification and the second notification.

8. The method of claim 7, wherein
the request message comprises reporting information that comprises the first MCI, the second MCI, a target address, and a correlation identifier,
transmitting the notification request message comprises transmitting the notification request message to the target address, and
the notification further comprises the correlation ID.

9. A method performed by a network function (NF), the method comprising:
transmitting a message for creating a session, wherein the message comprises i) information requesting quality-of-service (QoS) monitoring for the session and ii) at least one of an application identifier (AppID) that identifies an application and/or a first flow description (FD) that defines a first packet flow; and
receiving a first notification transmitted by a user plane function (UPF), the first notification comprising: i) first QoS information pertaining to the first packet flow and ii) at least one of the AppID or the first FD, thereby enabling the NF to associate the first QoS information with the AppID and/or first FD.

10. The method of claim 9, wherein the notification further comprises an event type indicator indicating an event for which the notification is generated.

11. The method of claim 9, wherein
the message comprises the first FD, and
the first FD is either an Ethernet FD or an Internet Protocol (IP) FD.

12-13. (canceled)

14. The method of claim 9, wherein
the message comprises the first FD,
the message further comprises a second FD that defines a second packet flow, and
the method further comprises receiving a second notification transmitted by the UPF, the second notification comprising: i) second QoS information for the second packet flow and ii) the second FD, thereby enabling the NF to associate the second QoS information with the second FD.

15-16. (canceled)

17. The method of claim 9, wherein the network function is:
an Application Function, or
a Network Exposure Function.

18. A non-transitory computer readable storage medium storing a computer program comprising instructions which when executed by processing circuitry of a network node causes the network node to perform the method of claim 1.

19-20. (canceled)

21. A network node, the network node comprising:
processing circuitry; and
a memory containing instructions executable by the processing circuitry, wherein the network node is configured to perform the method of claim 1.
